(19) United States
(12) Patent Application Publication
(10) Pub. No.: US 2024/0158574 A1
(43) Pub. Date: May 16, 2024

(54) POLYETHERETHERKETONE AND METHOD FOR PRODUCING THE SAME

(71) Applicant: IDEMITSU KOSAN CO.,LTD., Tokyo (JP)

(72) Inventors: Soshi NAMIKI, Tokyo (JP); Takehiro FUJITA, Tokyo (JP); Hiromu KUMAGAI, Tokyo (JP); Yuko HOSHI, Tokyo (JP)

(73) Assignee: IDEMITSU KOSAN CO.,LTD., Tokyo (JP)

(21) Appl. No.: 18/288,521

(22) PCT Filed: Apr. 27, 2022
(86) PCT No.: PCT/JP2022/019066

§ 371 Date: Oct. 26, 2023

(30) Foreign Application Priority Data
Apr. 27, 2021 (JP) 2021-074771

(51) Int. Cl. C08G 65/40

(52) U.S. Cl. CPC C08G 65/40

(57) ABSTRACT

A polyetheretherkenote comprising a repeating unit represented by the following formula (1) and a terminal structure represented by the following formula (2):

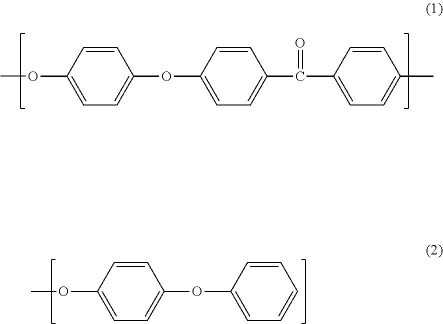

### TECHNICAL FIELD

The present invention relates to polyetheretherkenote and a method for producing the same.

Specifically, the present invention relates to polyetheretherkenote having excellent processability and a method for producing the same.

### BACKGROUND ART

Polyetheretherketone (abbreviation: “PEEK”), which is a kind of crystalline aromatic polyether, is known.

PEEK has excellent heat resistance and mechanical strength, and is used as a metal replacement material because of these characteristics. In recent years, its applications have expanded to automobiles, aircraft, medical fields, and the like.

The Patent Document 1 discloses that PEEK having an ionic group (-A-X; A is an anion, and X is a metal cation) at the terminal of a molecular chain exhibits a high crystallization temperature T_{c}.

### RELATED ART DOCUMENTS

### Patent Documents

[Patent Document 1] JP S60-163926 A

### SUMMARY OF THE INVENTION

When processing (for example, forming) PEEK, processing at high temperature is required because of its excellent heat resistance. At this time, in order to satisfactorily impart PEEK crystalline resinous characteristics to a workpiece (for example, a formed body), the temperature needs to be lowered over a long period of time so that PEEK is sufficiently crystallized, and thus, processability (particularly, compatibility between productivity and crystallinity) is difficult to obtain.

If the difference between the crystallization temperature T_{c} and the melting point Tₘ can be reduced by increasing the crystallization temperature T_{c} of PEEK, crystallization can be advanced at a temperature near the melting point Tₘ, and thus processability may be increased.

However, as a technique for increasing the crystallization temperature T_{c} of PEEK, the process of introducing a particular ionic group at the terminal as disclosed in Patent Document 1 has limitations in heat resistance and chemical resistance.

An object of the present invention is to provide PEEK having excellent processability and a method for producing the same.

As a result of intensive studies, the inventors have found that a particular PEEK is excellent in the above-described processability, and have completed the present invention.

According to the present invention, the following PEEK and so on can be provided.

1. A polyetheretherkenote comprising a repeating unit represented by the following formula (1) and a terminal structure represented by the following formula (2):

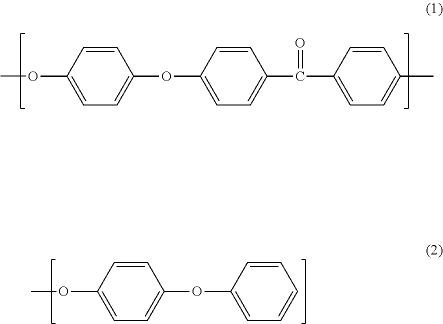

2. The polyetheretherkenote according to 1, wherein a ratio of the intensity of the phenoxyphenol unit peak to the intensity of the main chain peak in ¹H-NMR measurement is 0.0150% or more.

3. The polyetheretherkenote according to 1 or 2, wherein a melt flow rate is 200 g/10 min or smaller.

4. The polyetheretherkenote according to any one of 1 to 3, wherein a crystallization temperature T_{c} is 260° C. or higher.

5. The polyetheretherkenote according to any one of 1 to 4, wherein a melting point Tₘ is 300° C. or higher.

6. The polyetheretherkenote according to any one of 1 to 5, wherein an exothermic peak width due to crystallization observed in differential scanning calorimetry is 23.7° C. or narrower.

7. The polyetheretherkenote according to any one of 1 to 6, not comprising a repeating unit represented by the following formula (6), or comprising a repeating unit represented by the formula (6),
wherein in the case when the polyetheretherkenote comprises the repeating unit represented by the formula (6), a molar ratio of the repeating unit represented by the formula (6) relative to a sum of the repeating unit represented by the formula (1) and the repeating unit represented by the formula (6) is less than a 25 mol %.

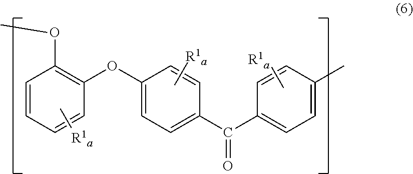

wherein in the formula (6), three R¹'s are independently selected from the group consisting of a halogen atom, an alkyl group, an alkenyl group, an alkynyl group, an aryl group, an ether group, a thioether group, a carboxylic acid group, an ester group, an amide group, an imide group, an alkali or alkaline earth metal sulfonate group, an alkyl sulfonate group, an alkali or alkaline earth metal phosphonate group, an alkyl phosphonate group, an amine group, and a quaternary ammonium group; three a's are independently selected from the group consisting of an integer of 0 to 4.

8. The polyetheretherkenote according to any one of 1 to 7, wherein the content of the chlorine atom is 2 mg/kg or more.

9. The polyetheretherkenote according to any one of 1 to 8, produced using at least hydroquinone and 4,4′-dichlorobenzophenone as monomers.

10. A method for producing the polyetheretherketone according to any one of 1 to 9, comprising
a step of reacting hydroquinone and 4,4′-dihalogenobenzophenone;
wherein in the case when the amount of the hydroquinone to be subjected to the reaction is a mol and the amount of the 4,4 ′-dihalogenobenzophenone is b mol, a condition b/a<1.00 is satisfied.

11. The method for producing the polyetheretherkenote according to 10, wherein the condition b/a≤0.99 is satisfied.

12. A method for producing the polyetheretherketone according to any one of 1 to 9, comprising
a step of reacting hydroquinone, 4,4′-dihalogenobenzophenone, and one or more selected from the group consisting of 4-phenoxyphenol and 4-halogenodiphenyl ether.

13. The method for producing the polyetheretherkenote according to any one of 10 to 12, wherein the 4,4′-dihalogenobenzophenone is one or more selected from the group consisting of 4,4′-difluorobenzophenone and 4,4′-dichlorobenzophenone.

14. The method for producing the polyetheretherkenote according to any one of 10 to 13, comprising heating a reaction mixture at a temperature of 250° C. or higher for 3 hours or longer.

According to the present invention, PEEK having excellent processability and a method for producing the same can be provided.

### BRIEF DESCRIPTION OF THE DRAWINGS

FIG. 1 shows DSC curves measured in Examples 1 to 3 and Comparative Example 2.

FIG. 2 shows ¹H-NMR spectrum measured in Example 3.

FIG. 3 shows ¹H-NMR spectrum measured in Comparative Example 3.

### MODE FOR CARRYING OUT THE INVENTION

Hereinafter, the polyetheretherkenote and the method for producing the same of the present invention will be described in detail.

In this specification, the upper and lower limits described for the numerical value range can be combined arbitrarily.

Also, among the individual embodiments of the aspects according to the present invention described below, it is possible to combine two or more embodiments that do not conflict with each other, and one embodiment combining two or more embodiments is also one embodiment of the aspects according to the present invention.

### 1. Polyetheretherkenote

PEEK according to one aspect of the present invention contains a repeating unit represented by the following formula (1) and a terminal structure represented by the following formula (2).

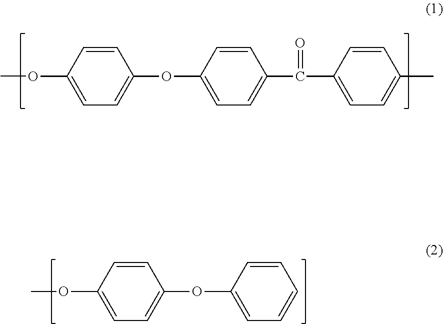

PEEK according to this aspect has a high crystallization temperature T_{c} due to the introduction of the terminal structure represented by the formula (2) into the terminal of the molecular chain composed of the repeating units represented by the formula (1). Further, even if the crystallization temperature T_{c} of PEEK is increased with the introduction of the terminal structure represented by the formula (2), the change in the melting point Tₘ tends to be suppressed. As a result, the difference between the crystallization temperature T_{c} and the melting point Tₘ becomes small, and crystallization can proceed at a temperature near the melting point Tₘ, so that processability can be increased. For example, in processing by injection molding or the like, the smaller the difference between the crystallization temperature T_{c} and the melting point Tₘ, the faster the processing cycle (forming cycle) can be.

It can be confirmed by ¹H-NMR measurement that PEEK contains the repeating unit represented by the formula (1) and the terminal structure represented by the formula (2). When a main chain peak (chemical shift of 7.34 ppm in Example) and a phenoxyphenol (abbreviation “PhP”) unit peak (chemical shift of 7.04 ppm in Example) are observed in ¹H-NMR measurement, it is determined that PEEK contains the repeating unit represented by the formula (1) and the terminal structure represented by the formula (2). Specifically, confirmation is made by the method described in Examples. The main chain peak can vary in the range of ±0.02 ppm with a chemical shift of 7.34 ppm. Also, the PhP unit peak can be identified as a PhP unit peak, although the peak may vary from the chemical shift 7.04 ppm.

In one embodiment, PEEK has the ratio of the intensity of the PhP unit peak to the intensity of the main chain peak in ¹H-NMR measurement (hereinafter, also referred to as “peak intensity ratio”) of 0.150% or more, 0.200% or more, 0.300% or more, 0.500% or more, or 0.600% or more. The higher the peak intensity ratio, the higher the crystallization temperature T_{c} of PEEK. The upper limit of the peak intensity ratio is not particularly limited, and is, for example, 4.500% or less.

The peak intensity ratio is a value measured by the method described in Examples.

The melt flow rate of PEEK is not particularly limited.

In one embodiment, the melt flow rate of PEEK is 1500 g/10 min or smaller, 1000 g/10 min or smaller, 500 g/10 min or smaller, 300 g/10 min or smaller, 200 g/10 min or smaller, 100 g/10 min or smaller, 80 g/10 min or smaller, 50 g/10 min or smaller, 30 g/10 min or smaller, 20 g/10 min or smaller, 15 g/10 min or smaller, and 0.0001 g/10 min or larger, 0.0005 g/10 min or larger, or 0.001 g/10 min or larger.

The melt flow rate of PEEK is preferably 200 g/10 min or smaller, 160 g/10 min or smaller, 100 g/10 min or smaller, 50 g/10 min or smaller, and more preferably 20 g/10 min or smaller. PEEK having the melt flow rate of 200 g/10 min or smaller is sufficiently polymerized, and thus is suitable for pelletizing by, for example, an extruder or the like. Such pellets are preferably applicable to applications such as injection molding.

The melt flow rate is a value measured by the method described in Examples.

The crystallization temperature T_{c} of PEEK is not particularly limited. The crystallization temperature T_{c} of PEEK tends to increase with the introduction amount of the terminal structure represented by the formula (2) (the above-described peak intensity ratio is exemplified as an index of the introduction amount).

In one embodiment, the crystallization temperature T_{c} of PEEK is 257° C. or higher, 258° C. or higher, 259° C. or higher, or 260° C. or higher, and 310° C. or lower, 300° C. or lower, 295° C. or lower, or 290° C. or lower.

The crystallization temperature T_{c} of PEEK is preferably 260° C. or higher, 265° C. or higher, 270° C. or higher, 275° C. or higher, and more preferably 280° C. or higher.

The crystallization temperature T_{c} is a value measured by the methods described in Examples.

The glass-transition temperature T_{g} of PEEK is not particularly limited.

In one embodiment, a glass-transition temperature T_{g} of PEEK is 130° C. or higher, 135° C. or higher, 140° C., 145° C. or higher, 148° C. or higher, 149° C. or higher, or 150° C. or higher, and is 165° C. or lower, 160° C. or lower, or 155° C. or lower.

The glass-transition temperature T_{g} is preferably 148° C. or higher. As a result, this has the effect of broadening the usable temperature range of products containing PEEK.

The glass-transition temperature T_{g} is a value measured by the methods described in Examples.

The melting point Tₘ of PEEK is not particularly limited.

In one embodiment, the melting point Tₘ of PEEK is 300° C. or higher, 310° C. or higher, 320° C. or higher, or 325° C. or higher, and 350° C. or lower, 340° C. or lower, or 335° C. or lower.

The melting point Tₘ of PEEK is preferably 300° C. or higher. As a result, this has the effect of broadening the usable temperature range of products containing PEEK.

The melting point Tₘ of PEEK is preferably 340° C. or lower. As a result, this has the effect of increasing the workability and reducing the processing cost by lowering the process temperature of PEEK (heating temperature such as injection molding).

The melting point Tₘ is a value measured by the methods described in Examples.

The difference between the crystallization temperature T_{c} and the melting point Tₘ of PEEK (Tₘ-T_{c}) is not particularly limited.

In one embodiment, Tₘ−T_{c} is 25° C. or higher, 30° C. or higher, 35° C. or higher, or 40° C. or higher, and is 90° C. or lower, 85° C. or lower, 80° C. or lower, 75° C. or lower, 73° C. or lower, 70° C. or lower, 65° C. or lower, 60° C. or lower, 55° C. or lower, 50° C. or lower, or 45° C. or lower.

These upper limit and lower limit can be arbitrarily combined, and Tₘ−T_{c} can be, for example, 40° C. or higher and 73° C. or lower, 40° C. or higher and 70° C. or lower, 40° C. or higher and 65° C. or lower, 40° C. or higher and 60° C. or lower, 40° C. or higher and 55° C. or lower, 40° C. or higher and 50° C. or lower, or 40° C. or higher and 45° C. or lower.

In one embodiment, the exothermic peak width due to crystallization observed in differential scanning calorimetry (DSC) of PEEK is 23.7° C. or narrower, 23.5° C. or narrower, 20.0° C. or narrower, 18.0° C. or narrower, 15.0° C. or narrower, 12.0° C. or narrower, 10.0° C. or narrower, or 9.0° C. or narrower. As a result, the crystallization rate of PEEK can be increased, and the processability can be further increased. The lower limit of the exothermic peak width is not particularly limited, and is, for example, 5.0° C. or wider.

These upper limit and lower limit can be arbitrarily combined, and the exothermic peak width can be, for example, 5.0° C. or wider and 23.7° C. or narrower, 5.0° C. or wider and 23.5° C. or narrower, 5.0° C. or wider and 12.0° C. or narrower, 5.0° C. or wider and 10.0° C. or narrower, or 5.0° C. or wider and 9.0° C. or narrower.

The exothermic peak width is a value measured by the method described in Examples.

The exothermic peak width can be adjusted by, for example, the content of the terminal structure represented by the formula (2) in PEEK. Usually, as the content of the terminal structure represented by the formula (2) in PEEK increases, the exothermic peak width decreases.

Some or all of the terminals (usually two terminals) among all terminals of the molecular chains constituting PEEK (one terminal or both terminals when the two terminals are present) may have a terminal structure represented by the formula (2).

Among the terminals of the molecular chains constituting PEEK, the terminal having the terminal structure represented by the formula (2) is represented by, for example, the following formula (3) or (4).

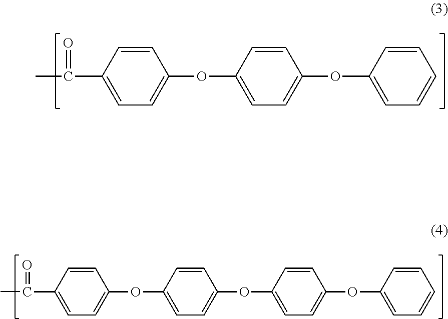

That is, in PEEK, the terminal structure represented by the formula (2) may form the terminal structure represented by the formula (3) or (4). The carbonyl group in the formulas (3) and (4) may correspond to the carbonyl group in the formula (1). PEEK may have only one of the terminals represented by the formulas (3) and (4), or may have both of the terminal represented by the formulas (3) and (4).

In PEEK, the terminal having the terminal structure represented by the formula (2) is not limited to the examples of the formulas (3) and (4), as long as the terminal has a terminal structure represented by the formula (2).

The terminal structure of the terminal of PEEK having no terminal structure represented by the formula (2) is not particularly limited, and may be any structure, and may be, for example, a hydrogen atom, a halogen atom, or the like. The terminal structure of the terminal having no terminal structure represented by the formula (2) may be, for example, a terminal structure in which an arbitrary structure (for example, a hydrogen atom, a halogen atom, or the like) is bonded to the right terminal or the left terminal of the repeating unit represented by the formula (1).

In PEEK of this aspect, it is not essential to have an ionic group (-A-X; A is an anion and X is a metal cation) as described in Patent Document 1 at the terminal of the molecular chains, and it is preferable not to have such an ionic group.

In one embodiment, PEEK does not contain other repeating units than the repeating unit represented by the formula (1). However, the terminal of the molecular chain may have a terminal structure as described above.

In one embodiment, PEEK contains a structural unit other than the repeating unit represented by the formula (1) and the terminal structure represented by the formula (2) as long as the effect of the present invention is not impaired. The other structural unit is not particularly limited, and examples thereof include those having different linking positions in the formula (1) or the terminal structure represented by formula (2) (those having a non-para linking position) and the like. Examples of the other structural unit include a structural unit represented by the following formula (5) (polyetheretheretherketone (PEEEK) structural unit).

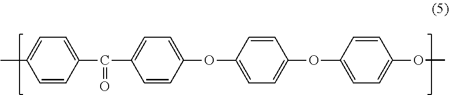

The repeating unit represented by the formula (1) and the repeating unit represented by the formula (5) are different from each other, and in an aromatic polyether copolymer, the partial structure corresponding to the repeating unit represented by the formula (5) is regarded as the repeating unit represented by the formula (5), and is not regarded as the repeating unit represented by the formula (1).

In one embodiment, PEEK does not contain a repeating unit represented by the following formula (6) or contains a repeating unit represented by the formula (6).

When PEEK contains the repeating unit represented by the formula (6), the molar ratio of the repeating unit represented by the formula (6) to the sum of the repeating unit represented by the formula (1) and the repeating unit represented by the formula (6) is less than 25 mol %, 20 mol % or less, 15 mol % or less, 10 mol % or less, less than 5 mol %, 4 mol % or less, 3 mol % or less, lmol % or less, 0.5 mol % or less, 0.3 mol % or less, or 0.1 mol % or less.

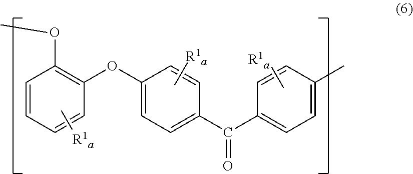

In the formula (6), three R¹'s are independently selected from the group consisting of a halogen atom, an alkyl group, an alkenyl group, an alkynyl group, an aryl group, an ether group, a thioether group, a carboxylic acid group, an ester group, an amide group, an imide group, an alkali or alkaline earth metal sulfonate group, an alkyl sulfonate group, an alkali or alkaline earth metal phosphonate group, an alkyl phosphonate group, an amine group, and a quaternary ammonium group. Three a's are independently selected from the group consisting of an integer of 0 to 4. All three a's may be 0.

The molar ratio described above has the effect that the smaller the molar ratio, the increased the crystallinity of PEEK, the increased the melting point Tₘ and the crystallization temperature T_{c} of PEEK, and the wider the usable temperature range of the product containing PEEK; and when the molar ratio is less than 25 mol %, this effect is remarkably achieved, and when the molar ratio is less than 5 mol %, this effect is particularly remarkably achieved. From the viewpoint of achieving this effect, it is most preferable that PEEK does not contain the repeating units represented by the formula (6) (the above molar ratio is 0 mol %).

In one embodiment, the proportion (% by mass) of the repeating unit represented by the formula (1) relative to
(i) a moiety in which terminal structures are excluded from the entire PEEK, or
(ii) a total of all repeating units constituting PEEK
is 50% by mass or more, 60% by mass or more, 70% by mass or more, 80% by mass or more, 90% by mass or more, 95% by mass or more, 97% by mass or more, 99% by mass or more, 99.5% by mass or more, or 100% by mass.

### 2. Method for Producing Polyetheretherkenote

### (First Aspect of Method for Producing Polyetheretherkenote)

A first aspect of the method for producing PEEK according to the present invention is a method for producing PEEK according to an aspect of the above-described present invention, the method contains a step of reacting hydroquinone with 4,4′-dihalogenobenzophenone, wherein in the case when the amount of the hydroquinone to be subjected to the reaction is a mol and the amount of the 4,4 ′-dihalogenobenzophenone is b mol, the condition b/a<1.00 is satisfied.

Hydroquinone and 4,4′-dihalogenobenzophenone are monomers for producing PEEK by polymerisation. When the amount of hydroquinone to be subjected to the reaction is larger than the amount of 4,4′-dihalogenobenzophenone (condition b/a<1.00 is satisfied), PEEK containing a repeating unit represented by the formula (1) and a terminal structure represented by the formula (2) can be suitably produced. This PEEK has a high crystallization temperature T_{c} and is excellent in processability as described for PEEK according to an aspect of the present invention.

In the conventional method for producing PEEK, the polymer is usually synthesized under the condition b/a=1.00, where the polymer theoretically has the highest molecular weight. On the other hand, in this aspect, by satisfying the condition b/a<1.00, PEEK containing the repeating unit represented by the formula (1) and the terminal structure represented by the formula (2) is preferably produced. In this aspect, for example, the molecular weight of PEEK containing the repeating unit represented by the formula (1) and the terminal structure represented by the formula (2) can be increased by increasing the total concentration of hydroquinone and 4,4′-dihalogenobenzophenone to be subjected to the reaction (details will be described later).

In one embodiment of the first aspect, a method for producing PEEK satisfies the condition b/a 0.99, b/a 0.98, or b/a 0.97, for example.

A method for producing PEEK preferably satisfies the condition b/a 0.98. This allows the crystallization temperature T_{c} of the obtained PEEK to be higher.

The lower limit of b/a is not particularly limited, and may be, for example, 0.95 b/a.

In the first aspect, 4,4′-dihalogenobenzophenone subjected to the reaction is not particularly limited, and the two halogen atoms may be the same as or different from each other. The two halogen atoms may independently be a fluorine atom, a chlorine atom, a bromine atom, or an iodine atom.

In one embodiment of the first aspect, 4,4′-dihalogenobenzophenone is one or more selected from the group consisting of 4,4′-difluorobenzophenone and 4,4′-dichlorobenzophenone.

In the first aspect, PEEK according to an aspect of the present invention is obtained by reacting (polymerizing) these components in a reaction mixture in which hydroquinone and 4,4′-dihalogenobenzophenone are blended as monomers so as to satisfy the condition b/a<1.00.

In one embodiment of the first aspect, the reaction mixture contains a solvent. The solvent is not particularly limited, and for example, a neutral polar solvent can be used. Examples of the neutral polar solvent include N,N-dimethylformamide, N,N-diethylformamide, N,N-dimethylacetamide, N,N-diethylacetamide, N,N-dipropylacetamide, N,N-dimethylbenzamide, N-methyl-2-pyrrolidone, N-ethyl-2-pyrrolidone, N-isopropyl-2-pyrrolidone, N-isobutyl-2-pyrrolidone, N-n-propyl-2-pyrrolidone, N-n-butyl-2-pyrrolidone, N-cyclohexyl-2-pyrrolidone, N-methyl-3-methyl-2-pyrrolidone, N-ethyl-3-methyl-2-pyrrolidone, N-methyl-3,4,5-trimethyl-2-pyrrolidone, N-methyl-2-piperidone, N-ethyl-2-piperidone, N-isopropyl-2-piperidone, N-methyl-6-methyl-2-piperidone, N-methyl-3-ethylpiperidone, dimethyl sulfoxide, diethyl sulfoxide, 1-methyl-1-oxosulfolane, 1-ethyl-1-oxosulfolane, 1-phenyl-1-oxosulfolane, N,N′-dimethylimidazolidinone, diphenylsulfone, and the like. Among these, diphenylsulfone is particularly preferable. The reaction mixture may contain one or two or more kinds of solvents.

In one embodiment of the first aspect, the reaction mixture contains a base. The base is not particularly limited, and examples thereof include an alkali metal salt, and the like. Examples of the alkali metal salt include an alkali metal carbonate, an alkali metal bicarbonate, and the like. Examples of the alkali metal carbonate include potassium carbonate, lithium carbonate, rubidium carbonate, cesium carbonate, and the like. Examples of the alkali metal bicarbonate include lithium bicarbonate, sodium bicarbonate, potassium bicarbonate, rubidium bicarbonate, cesium bicarbonate, and the like. Among these, potassium carbonate is particularly preferable. The reaction mixture may contain one or two or more kinds of bases.

In one embodiment of the first aspect, the blending amount of the base in the reaction mixture (the total blending amount when two or more kinds of bases are blended) is 100 parts by mol or more, and 300 parts by mol or less, 250 parts by mol or less, 200 parts by mol or less, 180 parts by mol or less, 160 parts by mol or less, 140 parts by mol or less, or 120 parts by mol or less, based on the blending amount of hydroquinone as 100 parts by mol.

In the first aspect, the total concentration of hydroquinone and 4,4′-dihalogenobenzophenone in the reaction mixture (based on the blending amount) is not particularly limited.

In one embodiment, the total concentration of hydroquinone and 4,4′-dihalogenobenzophenone in the reaction mixture (based on the blending amount) is 1.0 mol/l or more, 1.2 mol/l or more, 1.3 mol/l or more, 1.4 mol/l or more, or 1.5 mol/l or more, and 6.0 mol/l or less, 5.0 mol/l or less, or 4.0 mol/l or less.

In one embodiment of the first aspect, no other monomer other than hydroquinone and 4,4′-dihalogenobenzophenone is used as the monomer to be subjected to the reaction described above.

In one embodiment of the first aspect, the monomer subjected to the above-described reaction may contain other monomers other than hydroquinone and 4,4′-dihalogenobenzophenone as long as the effect of the present invention is not impaired.

In one embodiment of the first aspect, the total blending amount (% by mass) of hydroquinone and 4,4′-dihalogenobenzophenone, based on the blending amount of all monomers in the reaction mixture, is 50% by mass or more, 60% by mass or more, 70% by mass or more, 80% by mass or more, 90% by mass or more, 95% by mass or more, 97% by mass or more, 99% by mass or more, 99.5% by mass or more, or 100% by mass.

In the first aspect, the reaction mixture may or may not contain other components than hydroquinone, 4,4′-dihalogenobenzophenone, a base, and a solvent.

In one embodiment of the first aspect, 70% by mass or more, 80% by mass or more, 90% by mass or more, 95% by mass or more, 99% by mass or more, 99.5% by mass or more, 99.9% by mass or more, or substantially 100% by mass of the reaction mixture at the start of the reaction is hydroquinone, 4,4′-dihalogenobenzophenone, the base, and the solvent.

In the case of “substantially 100% by mass,” inevitable impurities may be contained in the resin composition.

In the first aspect, the reaction of hydroquinone with 4,4′-dihalogenobenzophenone can be carried out under an inert gas atmosphere. Inert gas is not particularly limited, and examples thereof include nitrogen, argon gas, and the like.

In one embodiment of the first aspect, the reaction mixture is heated upon reaction of hydroquinone with 4,4′-dihalogenobenzophenone. The maximum temperature (maximum temperature reached) of the reaction mixture during the reaction is not particularly limited as long as PEEK is formed, and may be, for example, 250 to 350° C.

In one embodiment, the maximum temperature reached is higher than 200° C., 210° C. or higher, 220° C. or higher, 230° C. or higher, 240° C. or higher, 250° C. or higher, 260° C. or higher, 270° C. or higher, or 280° C. or higher. When the maximum temperature reached is 200° C. or lower, the terminal structure represented by the formula (2) is not introduced into PEEK.

When the reaction mixture is heated, heating at a temperature of 250° C. or higher is preferably continued for 3 hours or longer (in this time, it contains not only the time for keeping the temperature constant but also the time for raising the temperature and the time for lowering the temperature; the same shall apply hereinafter), more preferably continued for 3.5 hours or more. Further, among the duration of time such heating, the time for heating the reaction mixture to 280° C. or higher is preferably 1 hour or more, and more preferably 2 hours or more. In this way, the terminal structure represented by the formula (2) is preferably introduced into PEEK.

### (Second Aspect of Method for Producing Polyetheretherkenote)

The second aspect of a method for producing PEEK according to the present invention is a method for producing PEEK according to an aspect of the present invention, wherein the method contains a step of reacting hydroquinone, 4,4′-dihalogenobenzophenone, and one or more selected from the group consisting of 4-phenoxyphenol and 4-halogenodiphenylether.

Hydroquinone and 4,4′-dihalogenobenzophenone are monomers for producing PEEK by polymerisation. 4-phenoxyphenol and 4-halogenodiphenylether are also monomers, but in particular function as a terminal-capping agent and form a terminal structure represented by the formula (2) (hereinafter, 4-phenoxyphenol and 4-halogenodiphenylether are collectively referred to as “terminal-capping agent A”). Thus, PEEK containing the repeating unit represented by the formula (1) and the terminal structure represented by the formula (2) can be suitably produced. This PEEK has a high crystallization temperature T_{c} and is excellent in processability as described for PEEK according to an aspect of the present invention.

The halogen atom contained in 4-halogenodiphenylether used as the terminal-capping agent A is not particularly limited. Examples of the 4-halogenodiphenylether include 4-fluorodiphenylether, 4-chlorodiphenylether, 4-bromodiphenylether, 4-iododiphenylether, and the like. These may be used alone or in combination two or more thereof.

In one embodiment, 4-phenoxyphenol is used as the terminal-capping agent A.

In the second aspect, when the amount of hydroquinone to be subjected to the reaction is a mol and the amount of 4,4′-dihalogenobenzophenone is b mol, b/a is not particularly limited, and it is not essential to satisfy the condition b/a<1.00 as in the first aspect.

In the second aspect, the condition b/a<1.00 may be satisfied, and the condition 1.00 b/a may be satisfied.

In one embodiment of the second aspect, a method for producing PEEK satisfies the condition 1.00≤b/a or 1.01≤b/a, for example.

The upper limit of b/a is not particularly limited, and may be, for example, b/a≤1.10.

In the second aspect, the amount (blending amount) of the terminal-capping agent A to be subjected to the reaction is not particularly limited.

In the second aspect, the content of the terminal structure represented by the formula (2) in the obtained PEEK can be adjusted by the blending amount of the terminal-capping agent A. Usually, the content of the terminal structure represented by the formula (2) in the obtained PEEK can be increased by increasing the blending amount of the terminal-capping agent A.

In one embodiment of the second aspect, when the amount of hydroquinone to be subjected to the reaction is a mol and the amount of the terminal-capping agent A is c mol, the condition 0<c/a, 2.50×10⁻⁴≤c/a, or 1.25×10⁻³≤c/a is satisfied, and the condition c/a≤5.00×10⁻², c/a≤1.00×10⁻², c/a≤5.00×10⁻³, or c/a≤2.50×10⁻³ is satisfied.

Also in the second aspect, 4,4′-dihalogenobenzophenone to be subjected to the reaction is not particularly limited, and the description provided for the first aspect is incorporated.

In the second aspect, PEEK according to an aspect of the present invention is obtained by reacting (polymerizing, terminal-capping) hydroquinone, 4,4′-dihalogenobenzophenone, and terminal-capping agent A in a reaction mixture containing these components as monomers.

In one embodiment of the second aspect, the reaction mixture contains a solvent. The solvent is not particularly limited, and the description provided for the first aspect is incorporated.

In one embodiment of the second aspect, the reaction mixture contains a base. The type and amount of the base are not particularly limited, and the description provided for the first aspect is incorporated.

In the second aspect, the total concentration of hydroquinone and 4,4′-dihalogenobenzophenone in the reaction mixture (based on the blending amount) is not particularly limited, and the description provided for the first aspect is incorporated.

In one embodiment of the second aspect, no other monomer other than hydroquinone, 4,4′-dihalogenobenzophenone, and the terminal-capping agent A is used as the monomer to be subjected to the reaction described above. In the first aspect described above, the terminal-capping agent A is not essential, and may or may not be subjected to the reaction as the other monomer.

In one embodiment of the second aspect, the monomer to be subjected to the above-described reaction may contain other monomers other than hydroquinone, 4,4′-dihalogenobenzophenone, and terminal-capping agent A as long as the effect of the present invention is not impaired.

In one embodiment of the second aspect, the total blending amount (% by mass) of hydroquinone, 4,4′-dihalogenobenzophenone, and the terminal-capping agent A, based on the blending amount of all monomers in the reaction mixture, is 50% by mass or more, 60% by mass or more, 70% by mass or more, 80% by mass or more, 90% by mass or more, 95% by mass or more, 97% by mass or more, 99% by mass or more, 99.5% by mass or more, or 100% by mass.

In the second aspect, the reaction mixture may or may not contain other components than hydroquinone, 4,4′-dihalogenobenzophenone, a terminal-capping agent A, a base, and a solvent. For other components, the description provided for the first aspect is incorporated.

In one embodiment of the second aspect, 70% by mass or more, 80% by mass or more, 90% by mass or more, 95% by mass or more, 99% by mass or more, 99.5% by mass or more, 99.9% by mass or more, or substantially 100% by mass of the reaction mixture at the start of the reaction is
hydroquinone, 4,4′-dihalogenobenzophenone, the terminal-capping agent A, the base, and the solvent.

In the case of “substantially 100% by mass,” inevitable impurities may be contained in the resin composition.

Also in the second aspect, the reaction of hydroquinone with 4,4′-dihalogenobenzophenone and the terminal-capping agent A can be carried out under an inert gas atmosphere. The inert gas is not particularly limited, and examples thereof include nitrogen, argon gas, and the like.

In one embodiment of the second aspect, the reaction mixture is heated upon the reaction of hydroquinone with 4,4′-dihalogenobenzophenone and the terminal-capping agent A. For the maximum temperature (maximum temperature reached) of the reaction mixture during the reaction, the description provided for the first aspect is incorporated.

In the second aspect, the blending of the terminal-capping agent A into the reaction mixture may be before or after the start of the reaction of hydroquinone with 4,4′-dihalogenobenzophenone.

In one embodiment, PEEK according to an aspect of the present invention and PEEK produced by the method for producing PEEK according to an aspect of the present invention (in particular PEEK obtained according to the second aspect) have an integral ratio X in ¹H-NMR spectrum represented by the following equation (Iₓ) of more than 0%.

X[%]={(B/2)/(A/4)}×100 (Iₓ)

In the equation (Iₓ), A is an integral value in the range of the chemical shift of 7.32 ppm to 7.42 ppm, and B is an integral value in the range of the chemical shift of 7.89 ppm to 7.93 ppm.

In the integration range corresponding to the integral value A (the range of the chemical shift of 7.32 ppm to 7.42 ppm), peaks derived from the repeating unit represented by the formula (1) are observed.

In the integration range corresponding to the integral value B (range of the chemical shift of 7.89 ppm to 7.93 ppm), peaks derived from the chlorine atoms bonded to the terminal of the main chain of PEEK are observed.

The integral values A and B are determined on the basis of ¹H-NMR spectra by the following methods.

The integral value A was obtained as a value obtained by connecting the intensity of the chemical shift of 7.15 ppm and the intensity of the chemical shift of 7.42 ppm with a straight line (baseline), and by integrating the intensity relative to this baseline (the intensity when the intensity of the baseline is taken as 0) in the range of the chemical shift of 7.32 ppm to 7.42 ppm. In the case when no peaks are observed in the range of the chemical shift of 7.32 ppm to 7.42 ppm, the integral value A is 0.

The integral value B was obtained as a value obtained by connecting the intensity of the chemical shift of 7.89 ppm and the intensity of 7.93 ppm with a straight line (baseline), and by integrating the intensity relative to this baseline (the intensity when the intensity of the baseline is taken as 0) in the range of the chemical shift of 7.89 ppm to 7.93 ppm. In the case when no peaks are observed in the range of the chemical shift 7.89 ppm to 7.93 ppm, the integral value B is 0.

The integral ratio X of more than 0% indicates that PEEK in which a chlorine atom is bonded to at least one of the terminals of the main chain is present.

Examples of the method for obtaining PEEK having an integral ratio X of more than 0% include a method of using a monomer containing a chlorine atom (for example, dichlorobenzophenone or the like) as a monomer used as a raw material for PEEK

In one embodiment, PEEK according to an aspect of the present invention and PEEK produced by the method for producing PEEK according to an aspect of the present invention may or may not contain a fluorine atom. Also, in one embodiment, PEEK may or may not contain a chlorine atom.

Hereinafter, the content a of the fluorine atom and the content b of the chlorine atom in PEEK are values measured by the combustion ion chromatography method described in Examples.

In one embodiment, the content a of the fluorine atom in PEEK is less than 2 mg/kg. Thus, the effect of the present invention can be well exhibited. The lower limit is not particularly limited, and may be, for example, 0 mg/kg.

Here, the content a of the fluorine atom is the sum of the content a1 of the fluorine atom contained in the molecular structure of PEEK and the content a2 of the fluorine atom contained as a component not contained in the molecular structure of PEEK (free component).

In one embodiment, the content a of the fluorine atom in PEEK can be less than 2 mg/kg by not using a raw material containing a fluorine atom (e.g., 4,4′-difluorobenzophenone, etc.) in PEEK synthesis or by reducing the amount of the raw material containing a fluorine atom in PEEK synthesis.

In one embodiment, the free component in the content a2 of the fluorine atom is one or both of potassium fluoride and 4,4′-difluorobenzophenone.

In one embodiment, the content b of the chlorine atom of PEEK is 2 mg/kg or more, 10 mg/kg or more, 100 mg/kg or more, 500 mg/kg or more, 700 mg/kg or more, 1000 mg/kg or more, 2000 mg/kg or more, 33000 mg/kg or more, 4000 mg/kg or more. Thus, the effect of the present invention can be well exhibited. The upper limit is not particularly limited, for example, 10000 mg/kg or less, 9000 mg/kg or less, 8000 mg/kg or less, 7000 mg/kg or less, 6000 mg/kg or less, or 3000 mg/kg or less.

The content b of the chlorine atom in PEEK is, for example, 2 to 10000 mg/kg, preferably 300 to 6000 mg/kg, and more preferably 300 to 3000 mg/kg.

Here, the content b of the chlorine atom is the sum of the content b1 of the chlorine atom contained in the molecular structure of PEEK and the content b2 of the chlorine atom contained as a component not contained in the molecular structure of PEEK (free component).

In one embodiment, by containing 4,4′-dichlorobenzophenone as a raw material for synthesizing PEEK, the content b of chlorine atom in PEEK can be adjusted to 2 mg/kg or more. Further, by using 4,4′-dichlorobenzophenone and hydroquinone as a raw material for synthesizing PEEK and increasing the ratio of the amount of 4,4′-dichlorobenzophenone used relative to the amount of hydroquinone used, the content b of the chlorine atom in PEEK can be increased in a range of 2 mg/kg or more.

In one embodiment, the content b1 of the chlorine atom is 0 mg/kg or more, 100 mg/kg or more, 200 mg/kg or more, or 400 mg/kg or more. The upper limit is not particularly limited, and may be, for example, 10000 mg/kg or less, 9000 mg/kg or less, 8000 mg/kg or less, 7000 mg/kg or less, 6000 mg/kg or less, or 3000 mg/kg or less.

In one embodiment, the content b2 of the chlorine atom is 0 mg/kg or more, 2 mg/kg or more, 5 mg/kg or more, or 10 mg/kg or more. The upper limit is not particularly limited, and may be, for example, 500 mg/kg or less, 400 mg/kg or less, or 300 mg/kg or less.

In one embodiment, the free component in the content b2 of the chlorine atom is one or both of potassium chloride and 4,4′-dichlorobenzophenone.

The chlorine atom contained in PEEK as potassium chloride, which is the free component, can be determined by the following method.

### <Determination of Chlorine Atom Contained as Potassium Chloride as Free Component in PEEK>

The solid-state sample (PEEK) is ground in a blender, washed with acetone and water in this order, and dried in an explosion-proof dryer at 180° C. When the reaction mixture (product) immediately after the reaction to produce PEEK is used as a sample, the product is cooled and solidified to obtain the above-described solid-state sample after the completion of the reaction. The blender used is not particularly limited, and for example, 7010HS manufactured by WARING Products, Inc. can be used.

Approximately 1 g of the dried sample is weighed, and 100 ml (I: liter) of ultrapure water is added thereto, and the mixture is stirred at a liquid temperature of 50° C. for 20 minutes, allowed to cool, and filtered to separate the solid content and the aqueous solution. The aqueous solution is analyzed by ion chromatography and the chloride ion in the aqueous solution is quantified based on a calibration curve prepared from a reference of known concentrations. The condition of ion chromatography is as follows.

### <Ion Chromatography>

Analyzer: Metrohm 940 IC Vario
Column: (Metrosep A Supp 5 Guard) as a guard column and (Metrosep A Supp 4) as a separating column (both columns are manufactured by Metrohm AG) are connected to use
Eluent: Na₂CO₃ (1.8 mmol/I)+NaHCO (1.7 mmol/I)
Flow rate: 1.0 ml/min
Column temperature: 30° C.
Measurement mode: suppressor method
Detector: electrical conductivity detector

The chlorine atom contained in PEEK as 4,4′-dichlorobenzophenone, which is the free component, can be determined by the following method.

<Determination of Chlorine Atom Contained in PEEK as 4,4′-Dichlorobenzophenone, which is the Free Component>

The solid-state sample (PEEK) is ground in a blender, washed with acetone and water in this order, and dried in an explosion-proof dryer at 180° C. When the reaction mixture (product) immediately after the reaction to produce PEEK is used as a sample, the product is cooled and solidified to obtain the above-described solid-state sample after the completion of the reaction. The blender used is not particularly limited, and for example, 7010HS manufactured by WARING Products, Inc. can be used.

Approximately 1 g of the dried sample is weighed into an eggplant flask, to which 10 ml of acetone and boiling stone are added, and refluxed with heating in a water bath for 5 hours. After allowing to cool to room temperature, the solid content is removed by filtration. The resulting acetone solution is subjected to dryness by an evaporator and then redissolved by adding 10 ml of acetone with a hole pipette. The amount (mg/kg) of 4,4′-dichlorobenzophenone in the sample is calculated by measuring the redissolved solution by gas chromatography. The amount (mg/kg) of the chlorine atom contained in PEEK as 4,4′-dichlorobenzophenone, which is the free component, is converted using the following equation.

The amount of the chlorine atom contained in PEEK as 4,4′-dichlorobenzophenone, which is the free component (mg/kg)=the amount of 4,4′-dichlorobenzophenone in the sample (mg/kg)/251.11 (molecular weight of 4,4′-dichlorobenzophenone)×35.45 (atomic weight of chlorine)×2

The quantitative value of 4,4′-dichlorobenzophenone is determined based on a calibration curve prepared from a reference of known concentrations. The measurement conditions are shown below.

### <Gas Chromatography>

Analyzer: Agilent Technologies 7890B
GC columns: Agilent Technologies DB-5MS (length: 30 m, internal diameter: 0.25 mm, film thickness: 0.25 μm)
Injection port temperature: 250° C.
Oven temperature: set at 100° C. (1 min) and raised to 250° C. (10 min) at 30° C./min
Flow rate: 1 ml/min
Injection volume: 1 μl
Split ratio: 40:1
Detector: FID
Detector Temperature: 250° C.

In one embodiment, PEEK according to an aspect of the present invention and PEEK produced by the method for producing PEEK according to an aspect of the present invention are produced by using at least hydroquinone and 4,4′-dichlorobenzophenone as monomers.

### 3. Application

The application of PEEK according to an aspect of the present invention described above and PEEK produced by the method for producing PEEK according to an aspect of the present invention (hereinafter, these PEEK are simply collectively referred to as “PEEK”) is not particularly limited. PEEK is excellent in processability, and thus can be preferably applied to various processes.

It is preferred that PEEK is subjected to molding as an exemplary processing. Examples of the molding include a method in which PEEK is molded in melted state and then cooled to solidify. The molded body can be produced by molding PEEK. A conventional method such as injection molding, extrusion molding, blow molding can be used for molding. In addition, PEEK can be press-molded, and known methods such as a cold press method and a hot press method can be used. In addition, PEEK can be used in 3D printer inks and molded by a 3D printer.

PEEK may be subjected to forming a composite material containing PEEK and fibers as an exemplary processing. The fibers are not particularly limited and examples thereof include, for example, fibers of an inorganic compound. Examples of the fibers of an inorganic compound include glass fibers, carbon fibers, and the like. In the composite material, the fibers may be dispersed in PEEK, or the fibers (e.g., in the form of a cloth) may be impregnated with PEEK. The cloth is composed of fibers arranged in a plane. The cloth may be, for example, a woven fabric, a nonwoven fabric, a unidirectional material, and the like. The unidirectional material is composed of fibers aligned in one direction. The composite material may be subjected to the molding described above.

### EXAMPLES

Examples of the present invention will be described below, and the present invention is not limited to these Examples.

Hereinafter, in Examples 1 to 5, PEEK is produced according to the first aspect of the method for producing PEEK. In Examples 6 to 7, PEEK is produced according to the second aspect of the method for producing PEEK.

### Example 1

In a 300 ml separable flask, 0.1617 mol of hydroquinone and 0.1601 mol of 4,4′-dichlorobenzophenone were charged as monomers. To this separable flask, 0.2425 mol of potassium carbonate (K₂CO₃) (manufactured by JUNSEI CHEMICAL CO., LTD., special grade) was charged as a base, and 140 g of diphenylsulfone charged as a solvent.

A ribbon heater was wound around the top of the separable flask, and the glass wool was wound on the ribbon heater to keep the separable flask warm. The entire lower part of the separable flask was wrapped with a mantle heater. The reaction mixture in the separable flask was heated under nitrogen (flow rate: 0.1 L/min) and stirred using a mechanical stirrer.

The ribbon heater was set at 150° C. and the mantle heater was set at 165° C. and the reaction mixture was heated for 30 minutes while stirring at 100 rpm stirring rate, then the stirring rate was changed to 210 rpm and the reaction mixture was heated to 200° C. over 30 minutes.

After the temperature of the reaction mixture was raised, the temperature was maintained at 200° C. for 1 hour, and the temperature was raised again to 250° C. over 30 minutes.

After maintaining the temperature at 250° C. for 1 hour, the stirring rate was changed to 250 rpm, and the temperature was raised to 300° C. over 30 minutes.

After the temperature was raised, the temperature was maintained at 300° C. for 2 hours, the reaction was terminated, and the mother liquid was removed. The recovered product was ground and washed with acetone and water to obtain a polymer.

### <Evaluation Method>

### (1) Structural Analysis

Identification and primary structural analysis of the obtained polymer (sample) were performed by ¹H-NMR under the following conditions.

### [Measurement Conditions]

### Magnet: Ascend500

Spectrometer: AVANCE III HD
Probe: TCI cryoprobe, 5 mm in diameter
Number of integrations: 256 times
Wait time: 10 seconds
Sample preparation: 0.6 mL of methanesulfonic acid was added to about 20 mg of the sample and stirred for 1 hour. 0.4 mL of dideuteromethylene chloride was added thereto to prepare a measurement sample.

It was confirmed that the polymer contained the repeating unit represented by the formula (1) and the terminal structure represented by the formula (2) by observing both the main chain peak and the PhP unit peak in ¹H-NMR measurement of the polymer.

The PhP unit peak is observed as a peak of two ¹H respectively bonded to 2- and 6-positions of the terminal phenyl group in the terminal structure represented by the formula (2).

The intensity ratio (peak intensity ratio) of the intensity of the PhP unit peak (chemical shift 7.04 ppm) to the intensity of the main chain peak (chemical shift 7.34 ppm) in ¹H-NMR measurement of the polymer was determined according to the following equation.

Peak intensity ratio[%]=(intensity of PhP unit peak/intensity of main chain peak)×100.

### (2) Combustion Ion Chromatography

The content a of the fluorine atom and the content b of the chlorine atom in PEEK were measured by combustion ion chromatography.

Specifically, a sample was introduced into a combustion furnace, pyrolyzed in an argon gas atmosphere, and then burned in a gas containing oxygen, and the generated gas was collected in an absorption liquid, and then fluoride ions and chloride ions contained in the absorption liquid were measured by ion chromatography. The fluorine and chlorine contents were calculated using a calibration curve. The measurement conditions are shown below.

### <Sample Burning>

Combustor: AQF-2100H manufactured by NITTO SEIKO CO. LTD.
Combustion furnace preset temperature: 800° C. for the first stage, and 1000° C. for the second stage
Argon flow rate: 200 ml/min
Oxygen flow rate: 400 ml/min
Absorption liquid: ultrapure water containing hydrogen peroxide

### <Ion Chromatography>

Analyzer: Integrion manufactured by Thermo Fisher Scientific Inc.
Column: AS-12A/AG-12A
Eluent: Na₂CO₃ (2.7 mmol/I)+NaHCO (0.3 mmol/I)
Flow rate: 1.5 ml/min
Column temperature: 30° C.
Detector: electrical conductivity detector

The lower limit of quantification of the fluorine atom and the chlorine atom in the above-described measuring method is 2 mg/kg. The case when the content of these atoms is below the lower limit of quantification is shown as “<2” (mg/kg) in Table 1.

### (3) Measurement of Thermal Properties (Differential Scanning Calorimetry (DSC))

5 mg of the obtained polymer (sample) was weighed into an aluminum-made pan, and subjected to thermal scanning using a differential scanning calorimeter (“DSC8500” manufactured by PerkinElmer, Inc.).

Temperature scanning was carried out in the order of: temperature of the sample was raised at 20° C./min from 50° C. to 420° C. (first temperature rising), held at 420° C. for 1 minute, lowered at 20° C./min from 420° C. to 50° C. (first temperature lowering), held at 50° C. for 1 minute, and raised at 20° C./min from 50° C. to 420° C. (second temperature rising) with nitrogen flowing at 20 ml/min.

The crystallization temperature T_{c} was determined by reading exothermic peaks due to crystallization observed during the first temperature lowering. Further, the exothermic peak width was determined as the difference between the “extrapolation start point” and the “extrapolation end point” of the exothermic peak due to crystallization at the time of the first temperature lowering. Here, in the case of measurement at the time of temperature lowering, the “extrapolation start point” is a point (temperature) at which the tangent at the point of the maximum oblique degree on the high-temperature side of the peak intersects the baseline, and the “extrapolation end point” is a point (temperature) at which the tangent at the point of the maximum oblique degree on the low-temperature side of the peak intersects the baseline. Here, the differences between the “extrapolation start point” and the “extrapolation end point” were determined using the thermal analysis software “Pyris” manufactured by PerkinElmer, Inc.

The glass-transition temperature T_{g} was determined as the temperature of the displacement midpoint (midpoint of the displacement) by reading the baseline shift due to the glass-transition observed at the second temperature rising.

The melting point Tₘ was determined as the temperature of the peak top by reading the endothermic peak due to melting observed at the second temperature rising.

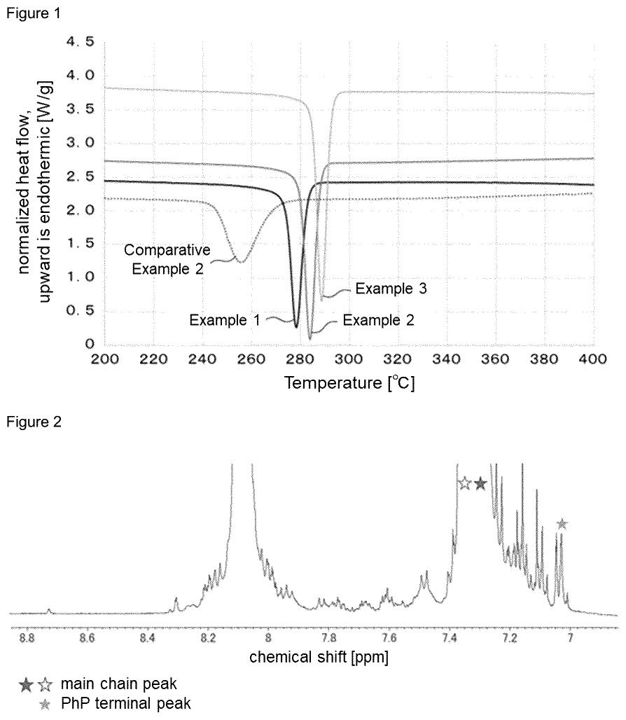

FIG. 1 shows DSC curve at the time of the first temperature lowering in DSC measurement. The vertical axis of DSC curve “normalized heat flow [W/g]” means a normalized heat flow per sample 1 g (change in heat per unit-time) [W].

### (4) Melt Flow Rate (MFR)

The melt flow rate of the obtained polymer (sample) was measured using a melt indexer (L-220) manufactured by TATEYAMA KAGAKU HIGH-TECHNOLOGIES CO., LTD., in accordance with JIS K 7210-1:2014 (ISO 1133-1:2011), under the following conditions.

### [Measurement Conditions]

Measurement Temperature: 380° C.
Measurement load: 2.16 kg
Cylinder internal diameter: 9.550 mm
Die internal diameter: 2.095 mm
Die length: 8.000 mm
Piston head length: 6.35 mm
Piston head diameter: 9.474 mm
Operation:

The sample was dried at 150° C. for 2 hours or more in advance. The sample was put into the cylinder, and the piston was inserted, and the sample was preheated for 6 minutes. A load was applied, the piston guide was removed, and the molten sample was extruded from the die. The sample was cut at a predetermined range and a predetermined time (t[s]) of piston movement, and weighed (m[g]). MFR was calculated from the following equation. MFR [g/10 min]=600/t×m

### Example 2

A polymer was obtained in the same manner as in Example 1 except that the input amount of hydroquinone was changed to 0.1617 mol, the input amount of 4,4′-dichlorobenzophenone was changed to 0.1585 mol, and the input amount of potassium carbonate (K₂CO₃) was changed to 0.2425 mol. The results evaluated in the same manner as in Example 1 are shown in Table 1. FIG. 1 shows DSC curve at the time of the first temperature lowering in DSC measurement.

### Example 3

A polymer was obtained in the same manner as in Example 1 except that the input amount of hydroquinone was changed to 0.1617 mol, the input amount of 4,4′-dichlorobenzophenone was changed to 0.1568 mol, and the input amount of potassium carbonate (K₂CO₃) was changed to 0.2425 mol. The results evaluated in the same manner as in Example 1 are shown in Table 1. FIG. 1 shows DSC curve at the time of the first temperature lowering in DSC measurement. Furthermore, ¹H-NMR spectrum is shown in FIG. 2.

### Example 4

A polymer was obtained in the same manner as in Example 1 except that the heating condition of the reaction mixture was changed to the below. The results evaluated in the same manner as in Example 1 are shown in Table 1.

### <Heating Conditions>

The ribbon heater was set at 150° C. and the mantle heater was set at 165° C. and the reaction mixture was heated for 30 minutes while stirring at 100 rpm stirring rate, then the stirring rate was changed to 210 rpm and the reaction mixture was heated to 200° C. over 30 minutes.

After the temperature of the reaction mixture was raised, the temperature was maintained at 200° C. for 1 hour, and the temperature was raised again to 250° C. over 30 minutes.

After maintaining the temperature at 250° C. for 1 hour, the stirring rate was changed to 250 rpm, and the temperature was raised to 320° C. over 30 minutes.

After the temperature was raised, the temperature was maintained at 320° C. for 2 hours, and then the reaction was terminated.

### Example 5

A polymer was obtained in the same manner as in Example 1 except that the heating condition of the reaction mixture was changed to the below. The results evaluated in the same manner as in Example 1 are shown in Table 1.

### <Heating Conditions>

The ribbon heater was set at 150° C. and the mantle heater was set at 165° C. and the reaction mixture was heated for 30 minutes while stirring at 100 rpm stirring rate, then the stirring rate was changed to 210 rpm and the reaction mixture was heated to 200° C. over 30 minutes.

After the temperature of the reaction mixture was raised, the temperature was maintained at 200° C. for 1 hour, and the temperature was raised again to 250° C. over 30 minutes.

After maintaining the temperature at 250° C. for 1 hour, the stirring rate was changed to 250 rpm, and the temperature was raised to 280° C. over 30 minutes.

After the temperature was raised, the temperature was maintained at 280° C. for 2 hours, and then the reaction was terminated.

### Comparative Example 1

A polymer was obtained in the same manner as in Example 1 except that the input amount of hydroquinone was changed to 0.1617 mol, the input amount of 4,4′-dichlorobenzophenone was changed to 0.1641 mol, and the input amount of potassium carbonate (K₂CO₃) was changed to 0.2425 mol. The results evaluated in the same manner as in Example 1 are shown in Table 1.

### Example 6

In a 300 ml separable flask, 0.1615 mol of hydroquinone and 0.1633 mol of 4,4′-dichlorobenzophenone were charged as monomers. Further, 0.0004043 mol of 4-phenoxyphenol was added thereto. To this separable flask, 0.1860 mol of potassium carbonate (K₂CO₃) was charged as a base, and 140 g of diphenylsulfone charged as a solvent.

A ribbon heater was wound around the top of the separable flask, and the glass wool was wound on the ribbon heater to keep the separable flask warm. The entire lower part of the separable flask was wrapped with a mantle heater. The reaction mixture in the separable flask was heated under nitrogen (flow rate: 0.1 L/min) and stirred using a mechanical stirrer.

The ribbon heater was set at 150° C. and the mantle heater was set at 165° C. and the reaction mixture was heated for 30 minutes while stirring at 100 rpm stirring rate, then the stirring rate was changed to 210 rpm and the reaction mixture was heated to 200° C. over 30 minutes.

After the temperature of the reaction mixture was raised, the temperature was maintained at 200° C. for 1 hour, and the temperature was raised again to 250° C. over 30 minutes.

After maintaining the temperature at 250° C. for 1 hour, the stirring rate was changed to 250 rpm, and the temperature was raised to 300° C. over 30 minutes.

After the temperature was raised, the temperature was maintained at 300° C. for 2 hours, the reaction was terminated, and the mother liquid was removed. The recovered product was ground and washed with acetone and water to obtain a polymer.

The results evaluated in the same manner as in Example 1 are shown in Table 1.

### Example 7

A polymer was obtained in the same manner as in Example 6, except that the input amount of hydroquinone was changed to 0.1614 mol and the input amount of 4-phenoxyphenol was changed to 0.0008085 mol. The results evaluated in the same manner as in Example 1 are shown in Table 1.

### Comparative Example 2

A polymer was obtained in the same manner as in Example 6, except that the input of 4-phenoxyphenol was omitted, the input amount of hydroquinone was changed to 0.1617 mol, the input amount of 4,4′-dichlorobenzophenone was changed to 0.1641 mol, and the input amount of potassium carbonate (K₂CO₃) was changed to 0.1860 mol. The results evaluated in the same manner as in Example 1 are shown in Table 1. FIG. 1 shows DSC curve at the time of the first temperature lowering in DSC measurement.

### Comparative Example 3

In a 2 L (liter) separable flask, 0.5775 mol of hydroquinone and 0.5717 mol of 4,4′-dichlorobenzophenone were charged as monomers. To this separable flask, 0.8663 mol of potassium carbonate (K₂CO₃) (manufactured by JUNSEI CHEMICAL CO., LTD., special grade) was charged as a base, and 408 g of diphenylsulfone charged as a solvent.

A ribbon heater was wound around the top of the separable flask, and the glass wool was wound on the ribbon heater to keep the separable flask warm. The entire lower part of the separable flask was wrapped with a mantle heater. The reaction mixture in the separable flask was heated under nitrogen (flow rate: 0.06 L/min) and stirred using a mechanical stirrer.

The ribbon heater was set at 150° C. and the mantle heater was set at 165° C., and held until the raw material melted. After the raw material was melt, the stirring rate was changed to 250 rpm and the reaction mixture was heated to 200° C. over 30 minutes.

After the temperature of the reaction mixture was raised, the temperature was maintained at 200° C. for 1 hour, and the temperature was raised again to 250° C. over 70 minutes.

After maintaining the temperature for 1 hour at 250° C., the temperature was raised to 300° C. over 110 minutes.

After the temperature rising was completed, a part of the mother liquid was withdrawn. The recovered product was ground and washed with acetone and water to obtain a polymer.

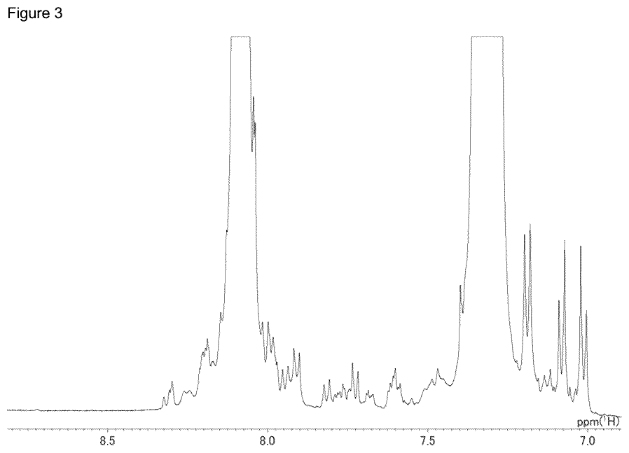

¹H-NMR spectrum is shown in FIG. 3. From ¹H-NMR spectrum of FIG. 3, it was found that the polymer of Comparative Example 3 did not show a peak derived from the terminal structure represented by formula (2), and did not have the terminal structure.

TABLE 1

| | Input molar | Input molar | Peak | Content of | Content of | | Exothermic | | | |
|---|---|---|---|---|---|---|---|---|---|---|
| | ratio b/a | ratio c/a | intensity | fluorine atom | chlorine atom | Tc | peak width | Tg | Tm | MFR |
| | [—] | [—] | ratio [%] | [mg/kg] | [mg/kg] | [° C.] | [° C.] | [° C.] | [° C.] | [g/10 min] |
| Example 1 | 0.99 | 0 | 0.686 | <2 | 510 | 278 | 8.94 | 151 | 330 | 0.017 |
| Example 2 | 0.98 | 0 | 1.448 | <2 | 420 | 284 | 8.21 | 148 | 331 | 14.92 |
| Example 3 | 0.97 | 0 | 2.191 | <2 | 320 | 289 | 7.66 | 143 | 330 | 155.20 |
| Example 4 | 0.99 | 0 | 1.041 | <2 | 400 | 280 | 11.18 | 151 | 329 | 5.2 |
| Example 5 | 0.99 | 0 | 0.485 | <2 | 2700 | 284 | 8.05 | 145 | 332 | 34.6 |
| Comp. Ex. 1 | 1.015 | 0 | 0 | <2 | 590 | 254 | 42.98 | 157 | 328 | 0.001 |
| Example 6 | 1.010 | 2.50 × 10⁻³ | 0.231 | <2 | 2600 | 263 | 20.31 | 151 | 331 | 4.1 |
| Example 7 | 1.010 | 5.00 × 10⁻³ | 0.331 | <2 | 2700 | 261 | 23.67 | 150 | 332 | 7.8 |
| Comp. Ex. 2 | 1.015 | 0 | 0 | <2 | — | 256 | 23.96 | 152 | 330 | 7.0 |

### <Evaluation>

From Table 1, it can be seen that in Examples 1 to 5, 6, and 7, the intensity ratio (peak intensity ratio) of the intensity of the PhP unit peak to the intensity of the main chain peak in ¹H-NMR measurement is greater than 0, and thus PEEK containing the repeating unit represented by the formula (1) and the terminal structure represented by the formula (2) was obtained. It can be seen that the crystallization temperature T_{c} is increased by the fact that PEEK contains the repeating units represented by the formula (1) and the terminal structures represented by the formula (2). On the other hand, it can be seen that the change of the melting point Tₘ is suppressed even when the terminal structure represented by the formula (2) is introduced.

In addition, it can be seen from Tables 1 and FIG. 1 that the crystallization rate is increased (the exothermic peak width is narrowed) when PEEK contains the repeating units represented by the formula (1) and the terminal structures represented by the formula (2).

From these results, it can be seen that PEEK having excellent processability can be obtained by the present invention.

Although only some exemplary embodiments and/or examples of this invention have been described in detail above, those skilled in the art will readily appreciate that many modifications are possible in the exemplary embodiments and/or examples without materially departing from the novel teachings and advantages of this invention. Accordingly, all such modifications are intended to be included within the scope of this invention.

The documents described in the specification and the specification of Japanese application(s) on the basis of which the present application claims Paris convention priority are incorporated herein by reference in its entirety.

1. A polyetheretherketone comprising a repeating unit represented by the following formula (1) and a terminal structure represented by the following formula (2):

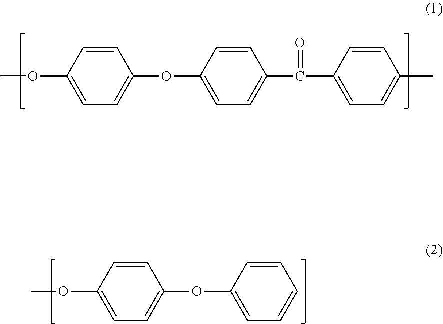

2. The polyetheretherketone according to claim 1, wherein a ratio of the intensity of the phenoxyphenol unit peak to the intensity of the main chain peak in ¹H-NMR measurement is 0.0150% or more.

3. The polyetheretherketone according to claim 1, wherein a melt flow rate is 200 g/10 min or smaller.

4. The polyetheretherketone according to claim 1, wherein a crystallization temperature T_{c} is 260° C. or higher.

5. The polyetheretherketone according to claim 1, wherein a melting point Tₘ is 300° C. or higher.

6. The polvetheretherketone according to claim 1, wherein an exothermic peak width due to crystallization observed in differential scanning calorimetry is 23.7° C. or narrower.

7. The polyetheretherketone according to claim 1, not comprising a repeating unit represented by the following formula (6), or comprising a repeating unit represented by the formula (6),
wherein in the case when the polyetheretherketone comprises the repeating unit represented by the formula (6), a molar ratio of the repeating unit represented by the formula (6) relative to a sum of the repeating unit represented by the formula (1) and the repeating unit represented by the formula (6) is less than 25 mol %: 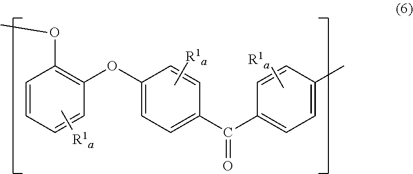
wherein in the formula (6), three R″s are independently selected from the group consisting of a halogen atom, an alkyl group, an alkenyl group, an alkynyl group, an aryl group, an ether group, a thioether group, a carboxylic acid group, an ester group, an amide group, an imide group, an alkali or alkaline earth metal sulfonate group, an alkyl sulfonate group, an alkali or alkaline earth metal phosphonate group, an alkyl phosphonate group, an amine group, and a quaternary ammonium group; three a's are independently selected from the group consisting of an integer of 0 to 4.

8. The polyetheretherketone according to claim 1, wherein the content of the chlorine atom is 2 mg/kg or more.

9. The polyetheretherketone according to claim 1, produced using at least hydroquinone and 4,4′-dichlorobenzophenone as monomers.

10. A method for producing the polyetheretherketone according to claim 1, comprising
a step of reacting hydroquinone and 4,4′-dihalogenobenzophenone;
wherein in the case when the amount of the hydroquinone to be subjected to the reaction is a mol and the amount of the 4,4 ′-dihalogenobenzophenone is b mol, a condition b/a<1.00 is satisfied.

11. The method for producing the polyetheretherketone according to claim 10, wherein the condition b/a≤0.99 is satisfied.

12. A method for producing the polyetheretherketone according to claim 1, comprising
a step of reacting hydroquinone, 4,4′-dihalogenobenzophenone, and one or more selected from the group consisting of 4-phenoxyphenol and 4-halogenodiphenyl ether.

13. The method for producing the polyetheretherketone according to claim 10, wherein the 4,4′-dihalogenobenzophenone is one or more selected from the group consisting of 4,4′-difluorobenzophenone and 4,4′-dichlorobenzophenone.

14. The method for producing the polyetheretherketone according to claim 10, comprising heating a reaction mixture at a temperature of 250° C. or higher for 3 hours or longer.
